(19) United States
(12) Patent Application Publication
(10) Pub. No.: US 2016/0072977 A1
(43) Pub. Date: Mar. 10, 2016

(54) INFORMATION PROCESSING APPARATUS, IMAGE FORMING APPARATUS, INFORMATION PROCESSING SYSTEM, INFORMATION PROCESSING METHOD, AND RECORDING MEDIUM

(71) Applicants: Kazuki SASAYAMA, Kanagawa (JP); Daisuke OKADA, Saitama (JP); Chan GU, Tokyo (JP); Yuto SHIBATA, Kanagawa (JP); Akiko KITAYAMA, Kanagawa (JP); Daisuke MASUI, Tokyo (JP); Masashi TANIGUCHI, Kanagawa (JP); Noboru TAMURA, Kanagawa (JP); Naoya TAMURA, Kanagawa (JP); Yuka SAITO, Tokyo (JP); Hiroya URUTA, Tokyo (JP)

(72) Inventors: Kazuki SASAYAMA, Kanagawa (JP); Daisuke OKADA, Saitama (JP); Chan GU, Tokyo (JP); Yuto SHIBATA, Kanagawa (JP); Akiko KITAYAMA, Kanagawa (JP); Daisuke MASUI, Tokyo (JP); Masashi TANIGUCHI, Kanagawa (JP); Noboru TAMURA, Kanagawa (JP); Naoya TAMURA, Kanagawa (JP); Yuka SAITO, Tokyo (JP); Hiroya URUTA, Tokyo (JP)

(73) Assignee: Ricoh Company, Ltd., Tokyo (JP)

(21) Appl. No.: 14/841,857

(22) Filed: Sep. 1, 2015

(30) Foreign Application Priority Data
Sep. 4, 2014 (JP) 2014-179792

(51) Int. Cl. H04N 1/32; H04N 1/00

(52) U.S. Cl. CPC H04N 1/32101; H04N 1/00095; H04N 1/00209; H04N 2201/3207; H04N 2201/3209; H04N 2201/0094

(57) ABSTRACT

An information processing apparatus includes an address information storage storing recipient information relating to a recipient and the recipient's address with an address identifier as address information; a program storage storing setting information in association with a program identifier as program information, the setting information including program identification information specifying a program and the address identifier; a program execution unit executing the program associated with the program identifier based on the setting information; an address information change unit changing the address information in the address information storage, and changing the address identifier along with the change in the address information; and an information change adjusting unit adjusting, upon detecting a change in one of the address identifier and the address information, the address identifier of the program information including the address identifier in the program storage in response to the change in the corresponding address identifier or the address information.

### BACKGROUND OF THE INVENTION

1. Field of the Invention

The disclosures discussed herein relate to an information processing apparatus, an image forming apparatus, an information processing system, an information processing method, and a non-transitory recording medium storing an information processing program.

2. Description of the Related Art

Recent information processing apparatuses including image forming apparatuses such as copiers, scanners, printers, facsimile machines and multifunction peripherals, and computers are configured to store recipients' information items and addresses as address information in storages.

Note that the address information items indicate destinations to which data such as image data are transmitted by using information processing apparatuses, including image forming apparatuses such as names of recipients, and recipients' identification information to identify the recipients. The addresses indicate mail addresses, facsimile numbers, and residential addresses used in operational processes of the information processing apparatuses. Each of such address information items is provided with address identification information (hereinafter called an “address ID”), so that the address information items are managed by the respective address IDs.

Since the image forming apparatuses store the address information items such as recipient' names, the recipients' addresses and the like, the image forming apparatuses are able to use the stored address information items or addresses in order to execute various types of programs such as a copy program, a facsimile program, and the like, which may facilitate the usability of the image forming apparatuses.

Meanwhile, the image forming apparatuses are configured to store various setting information (e.g., sheet sizes, resolution, addresses) for executing the programs, and program identification information (e.g., program names) for specifying the programs. The program information may include addresses in the setting information.

The image forming apparatuses storing the above program information are configured to execute the programs of the program information in association with the program identification information based on the setting information of the program information, upon specification of the program identification information. Thus, users may be able to simply specify the program identification information to cause image forming apparatuses to execute the programs such as a copying process, a facsimile transmission process and the like. The execution of the programs based on the program information may include outputting a result of the copying process to the destinations specified in the setting information, or transmitting facsimile documents to the addresses specified in the setting information.

To include the address information in setting information of the program information, the addresses themselves are not incorporated in the setting information but instead the address IDs for identifying the address information to be used are registered in the setting information of the program information.

Hence, in the execution of the programs based on the program information, the address information corresponding to the address IDs of the setting information are acquired and the acquired address information is output or transmitted to the address of the address information.

The information processing apparatus such as an image forming apparatus storing the address information such as addresses may require changing the address information or the address IDs when the address information or the addresses themselves are changed. Specifically, when there are two or more information processing apparatuses such as image forming apparatuses that store different registered address information items, the usability of the image forming apparatuses are degraded. Hence, such addresses sometimes need to be matched, unified, or integrated, and the address information may be changed as a result (e.g., Patent Document 1).

However, in the above-described related art technologies, the address information may be changed. However, since each of the address information items is managed by a corresponding one of the address IDs (i.e., the address identification information), the image forming apparatuses may exhibit erroneous operations when users specify the address information items using the address IDs to cause the image processing apparatuses to perform operational processes using such address information.

That is, in a case where the address information items are managed by the respective address IDs, and there occurs a change in the address information, there may be a mismatch between the address ID and the address information, or a different address information item may be registered in the same address ID. To prevent such a mismatch or erroneous registration, existing address information needs to be deleted.

Further, in this case, process information utilizing the address ID such as program information including the address ID in the setting information may further cause erroneous operations. Accordingly, it may be necessary to delete the address ID from the process information such as the program information to register the address ID again, or regenerate the process information itself to prevent erroneous operations or the like.

### RELATED ART DOCUMENT

### Patent Document

PATENT DOCUMENT 1: Japanese Laid-open Patent Publication No. 2011-259021

### SUMMARY OF THE INVENTION

Accordingly, it is a general object in one embodiment of the present invention to provide a technology capable of implementing appropriate process operations utilizing the address identifiers and the respective address identification information items associated with the address identifiers when there occurs a change in the address information managed by the address identifiers, which substantially obviate one or more problems caused by the limitations and disadvantages of the related art.

According to an aspect of embodiments, there is provided an information processing apparatus that includes an address information storage configured to store recipient information relating to a recipient and an address of the recipient in association with an address identifier as address information; a program storage configured to store setting information in association with the program identifier as program information, the setting information including program identification information for specifying a program and the address identifier for specifying the address for use in execution of the program; a program execution unit configured to execute the program associated with the program identifier based on the setting information; an address information change unit configured to change the address information stored in the address information storage, and change the address identifier along with the change in the address information; and an information change adjusting unit configured to adjust, upon detecting a change in at least one of the address identifier and the address information, the address identifier of the program information including the address identifier stored in the program storage based on the address identifier and the address information before being changed and the address identifier and the address information after being changed, in response to the change in a corresponding one of the address identifier and the address information.

Other objects, features and advantages of the present invention will become more apparent from the following detailed description when read in conjunction with the accompanying drawings.

### BRIEF DESCRIPTION OF THE DRAWINGS

FIG. 1 is a configuration diagram illustrating an image processing system to which an embodiment is applied;

FIG. 2 is a block diagram illustrating an image forming apparatus;

FIG. 3 is a diagram illustrating an example of an address book;

FIG. 4 is a diagram illustrating an example of a program information book;

FIG. 5 is an explanatory diagram illustrating a change caused by replacement of an address book;

FIG. 6 is an explanatory diagram illustrating a change caused by integration of address books;

FIGS. 7A and 7B are diagrams illustrating examples of address books included in two image forming apparatuses before integration of the address books;

FIG. 8 is a diagram illustrating an example of an integrated address book;

FIG. 9 is a flowchart illustrating an address book updating process; and

FIG. 10 is a flowchart illustrating a program information book updating process.

### DETAILED DESCRIPTION OF THE PREFERRED EMBODIMENTS

In the following, a description is given of embodiments of the present invention with reference to the accompanying drawings. Note that the embodiments described below include various preferable technical limitations; however, a scope of the present invention is not limited to such limitations described below, or all the components described below in the embodiments are not necessarily essential.

### First Embodiment

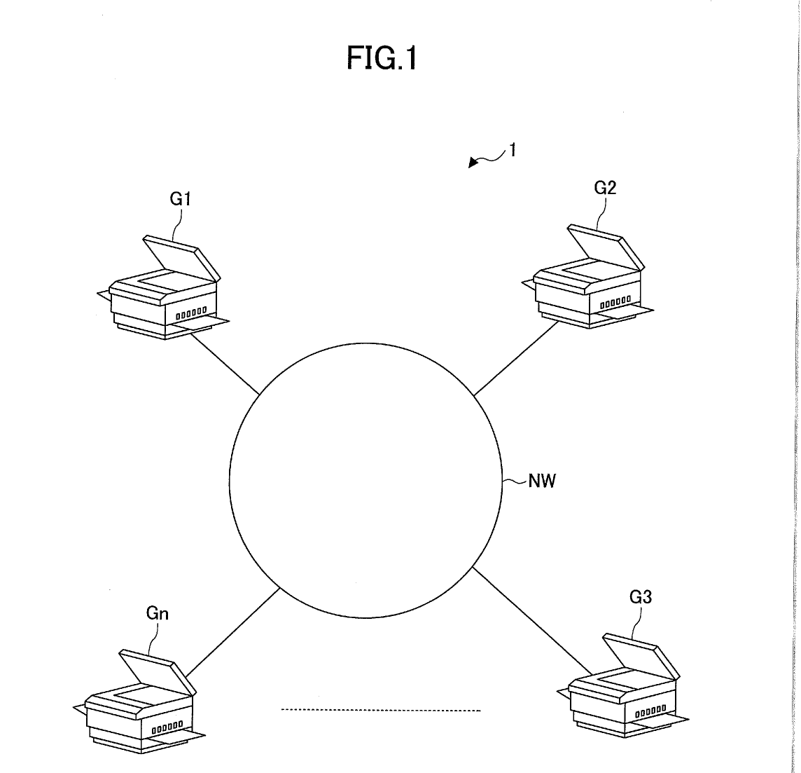

FIGS. 1 to 10 are diagrams illustrating examples of an information processing apparatus, an image forming apparatus, an information processing system, an information processing method, and an information processing program. FIG. 1 is a configuration diagram illustrating an information processing system 1 to which embodiments of the information processing apparatus, the image forming apparatus, the information processing system, the information processing method, and the information processing program are applied.

In FIG. 1, an information processing system 1 includes image forming apparatuses G1 to Gn connected to a network NW such as a LAN (local area network), a WAN (wide area network), and Ethernet. Note that a not-illustrated host apparatus such as a computer or the like is connected to the information processing system 1 so as to perform communications with the image forming apparatuses G1 to Gn to transmit print jobs to the image forming apparatuses G1 to Gn or to receive the image data or the like from the image forming apparatuses G1 to Gn.

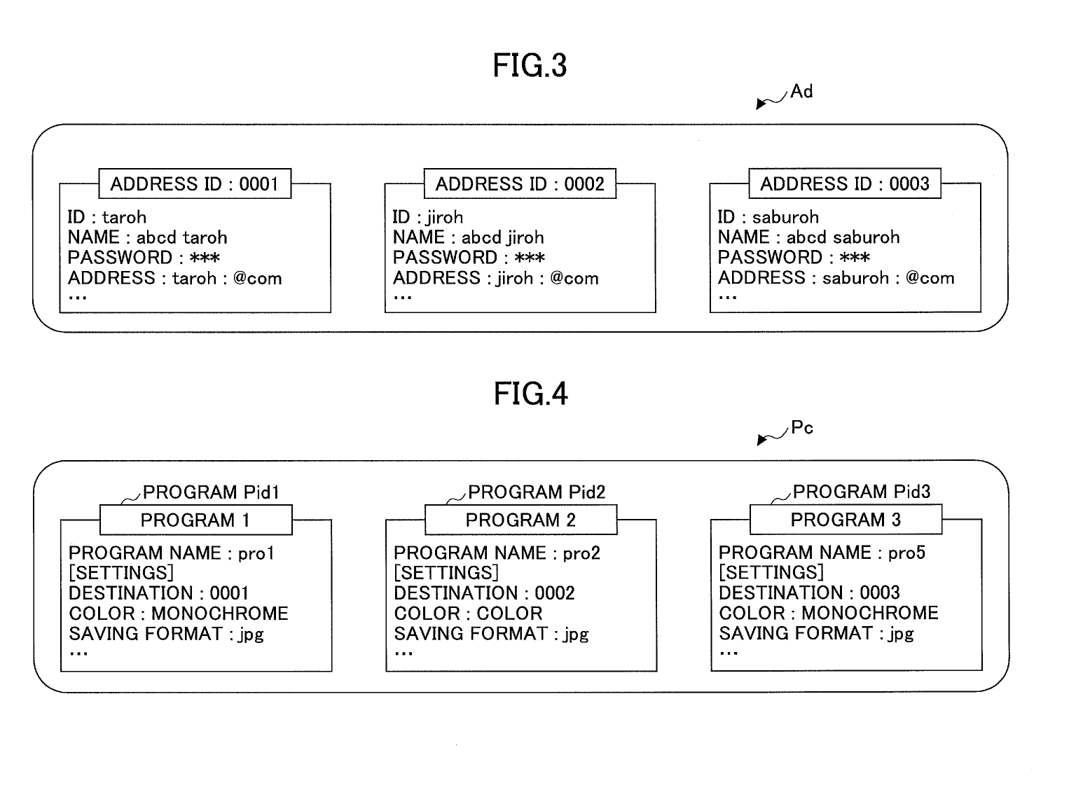

Each of the image forming apparatuses G1 to Gn includes an information processing apparatus (an information processing part) configured to store an address book Ad (see FIG. 3), and a program information book Pd (see FIG. 4) so as to manage the address book Ad and the program information book Pd.

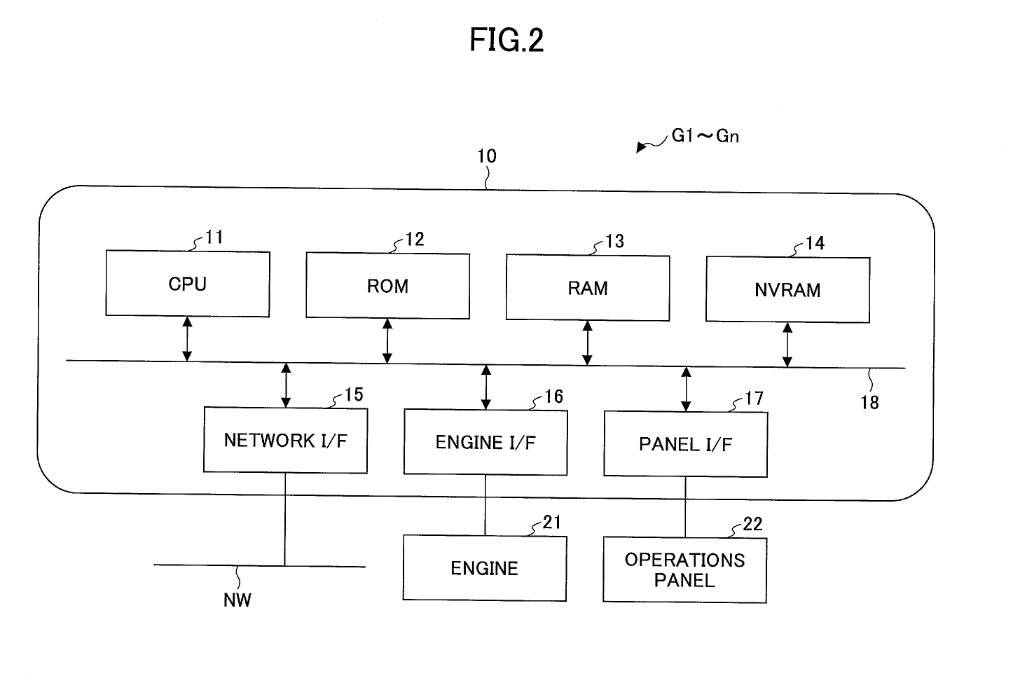

As illustrated in FIG. 2, each of the image forming apparatuses G1 to Gn has a block diagram configuration, and includes a controller 10, an engine 21, an operations panel 22, and the like.

The controller 10 includes a CPU (central processing unit) 11, a ROM (read only memory) 12, a RAM (random access memory) 13, an NVRAM (nonvolatile random access memory) 14, a network I/F (interface) 15, an engine I/F 16, and a panel I/F 17. The above-described components 11 to 17 are connected via a bus 18.

The engine 21 is a generic name of engines performing image processing such as a printer engine, a scanner engine, a facsimile engine, and the like. The printer engine is configured to perform an image recording process to form an image on a recording medium such as sheets or films in an appropriate printer system (e.g., electrophotographic printer system and inkjet printer system) based on image data transmitted from the controller 10. The scanner engine is configured to perform an input process such as main scanning or sub-scanning a document to read an image of the document at predetermined resolution and output the read image data to the controller 10. The facsimile engine is configured to receive facsimile data transmitted from a counterpart facsimile apparatus to perform a facsimile output process such as recording the image based on the facsimile data and outputting the recorded image. In addition, the facsimile engine is also configured to perform a facsimile transmission process such as facsimile transmitting the image data scanned by the scanner engine to the counterpart facsimile apparatus.

The operations panel 22 includes various types of operations keys necessary for operating the image forming apparatuses G1 to Gn, such as ten keys (numeric keys), a start key, a return key, a menu key as well as having a LCD (liquid crystal display), and the like. The operations panel 22 is configured to output operations content to the controller 10 when various types of operations for operating the image forming apparatuses G1 to Gn are performed via the operations keys, and display the display data from the controller 10 on a display. Note that the display may be provided with a touch-sensitive function configured to detect a touch operation on the display. In this case, the controller 10 displays various types of buttons on a screen of the display, and recognizes, upon detecting the touch operation on the function button, the detected touch operation as an operation of a button function assigned to a function button.

The ROM 12 stores programs for processing or managing data within the controller 10, and various types of necessary data. Specifically, the ROM 12 stores a basic process program as the image forming apparatuses G1 to Gn, and various types of programs such as firmware and an information processing program according to the embodiment as well as various data necessary for executing each of the programs.

The CPU 11 is configured to control each part of the image forming apparatuses G1 to Gn based on the programs stored in the ROM 12 so as to perform various types of image processes while using the RAM 13 as a work memory.

The RAM 13 is used as a work memory of the CPU 11. Further, the RAM 13 is also used as a buffer to temporarily store print data from the information processing part (the information processing apparatus), a bitmap memory loaded after converted from the print data into graphic data suitable for the actual printing, and a memory to temporarily store address information and the like processed by the image processing method according to the embodiment.

The NVRAM 14 serves as a memory configured to maintain storage contents of the image forming apparatuses G1 to Gn even though power of the image forming apparatuses G1 to Gn is tuned off. The NVRAM 14 maintains, for example, system setting values, address book Ad, and the program information book Pd used in the embodiments illustrated in FIGS. 3 and 4 as data necessary to be maintained under the control of the CPU 11 when the power of the image forming apparatuses G1 to Gn is turned off. Note that in FIG. 2, the image forming apparatuses G1 to Gn include the NVRAM 14 as a nonvolatile memory. However, the nonvolatile memory is not limited to the NVRAM 14, and may be a hard disk, an SSD (solid state drive), and the like.

The address book Ad may register address information such as an ID (identification) (a recipient's ID), a name of the recipient, a password, and an address, for each of the recipients, as illustrated in FIG. 3. The address book Ad includes address IDs (address identifiers) for identifying the address information items assigned to the respective address information items, which are managed by the assigned address IDs. The information registered in each address information of the address ID is not limited to the above-described information, and information may be added into or deleted from the address information of the address ID, or the address ID may be changed.

The program information book Pd may register program information for executing the programs in accordance with the setting contents that set the operational processes utilizing application programs of the image forming apparatuses G1 to Gn, by the respective program Pids (program identifiers) with the program information items. Each of the program information items registers a program name, and a setting value for executing the program having that program name as the setting information. Each of the setting information items may, for example, register an address (e.g., “destination” in of FIG. 4), color, a saving format, resolution, an image size, and the like. The addresses indicate the addresses registered in the address information of the address book Ad, and the addresses are specified by the respective address IDs of the address book Ad (i.e., “0001” in FIG. 3). Note that FIG. 4 illustrates an example of a program information book Pd of the scanner program; however, the image forming apparatuses G1 to Gn may be able to create similar program information books Pd in association with the copying programs, the facsimile transmission programs, the printer programs, and the like.

Accordingly, the NVRAM 14 may be able to function as an address information storage configured to store recipient information relating to a recipient, and an address of the recipient in association with the corresponding address identifier as address information.

In addition, the NVRAM 14 may function as a program storage configured to store setting information in association with the program Pid (program identifier) as program information, the setting information including program identification information for specifying the program names, and the address ID (address identifier) for specifying the address in the execution of the program.

The network I/F 15 is connected to the network NW, and configured to perform communications between the image forming apparatuses G1 to Gn and not-illustrated information processing apparatuses over the network NW under the control of the CPU 11. Specifically, the network I/F 15 is configured to transmit or receive the address book Ad between the image forming apparatuses G1 to Gn under the control of the CPU 11.

The engine I/F 16 is connected to the above engine 21. The engine I/F 16 is configured to output control signals or data such as image data from the controller 10 to the engine 21, and acquire status signals, scanner image data, received image data, and the like from the engine 21 to the controller 10.

The panel I/F 17 is connected to the operations panel 22, and configured to transmit or receive signals between the CPU 11 and the operations panel 22.

The above-described network I/F 15, the operations panel 22, and the like may function as a changed address information receiver configured to receive predetermined numbers of changed address IDs and address information.

Accordingly, the CPU 11 may function as a program execution unit configured to execute the above-described programs by controlling the engine 21 and the like based on the above seeing information. Further, the CPU 11 may function as an address information change unit configured to change the address information stored in the NVRAM 14 serving as the address information storage, and change the address IDs (address identifiers) along with the change the address information in response to information change operations from the operations panel 22, and information change requests received by the network I/F 15 from the other image forming apparatuses G1 to Gn the via the network NW. Further, the CPU 11 may function as an information change adjusting unit configured to change, when the address information is changed along with the change in the address ID has occurred, the address ID of the program information including the address ID of the NVRAM 14 serving as the program storage based on the address information before the change and the address information after the change.

Then, the controller 10 having the CPU 11, the ROM 12, the RAM 13, the NVRAM 14, the network I/F 15, the engine I/F 16, and the panel I/F 17 may also function as an information processing part configured to manage the programs and the address information.

Each of the image forming apparatuses G1 to Gn may be an image forming apparatus having the controller 10 serving as the information processing part (information identifier apparatus) configured to execute an information processing method that implements appropriate management of the address information and appropriate process operations using such appropriate address information by introducing an information processing program, able to execute the information processing method, stored in a non-transitory computer-readable recording medium even when the change has occurred in the address information managed by the address ID (address identifier information) of the later-described address book Ad. Examples of the non-transitory computer-readable recording medium include a ROM, an EEPROM (Electrically Erasable and Programmable Read Only Memory), an EPROM, a flash memory, a flexible disk, a CD-ROM (Compact Disc Read Only Memory), a CD-RW (Compact Disc Rewritable), a DVD (Digital Versatile Disk), a USB (Universal Serial Bus) memory, an SD (Secure Digital) card, an MO (Magneto-Optical Disc), and the like. The information processing program is a computer-executable program written in a legacy programming language or an object-oriented programming language such as assembler, C, C++, C#, or Java (registered trademark).

Next, functional properties of the embodiment are described. In the information processing system 1 of the embodiment, appropriate process operations using the address IDs may be implemented even when a change has occurred in the address information managed by the address IDs.

That is, in the information processing system 1, the image forming apparatuses G1 to Gn are connected to the network NW, and each of the image forming apparatuses G1 to Gn registers the address book Ad and the program information book Pd in the NVRAM 14 of the controller 10. Each of the image forming apparatuses G1 to Gn performs various types of operations utilizing the programs of the scanner process, the copying process, and the facsimile transmission process, under the control of the CPU 11. In this case, the image forming apparatuses G1 to Gn may be able to register the program names of the programs used in the operational processes and various types of setting information in the operational processes as the program information by being provided with the program Pids in the program information book Pd. A registration request of the program information may be implemented by operations from the operations panel 22, or a setting request from a host apparatus such as a computer connected to the network NW. Note that the program Pid is identification information for identifying each of the programs.

The program information may utilize addresses in the address book Ad for operational processes such as data transmission or data output to the addresses. In this case, each of the image forming apparatuses G1 to Gn specifies the addresses (destinations) illustrated as destinations in FIG. 4 by using the respective address IDs of the address book Ad illustrated in FIG. 3 in the setting information of the program information registered in the program information book Pd. Hence, when the content of the address information specified by the address ID of the address book is changed, appropriate operational processes based on the program information may fail to be performed.

On the other hand, address information of the address books Ad may be changed in the image forming apparatuses G1 to Gn.

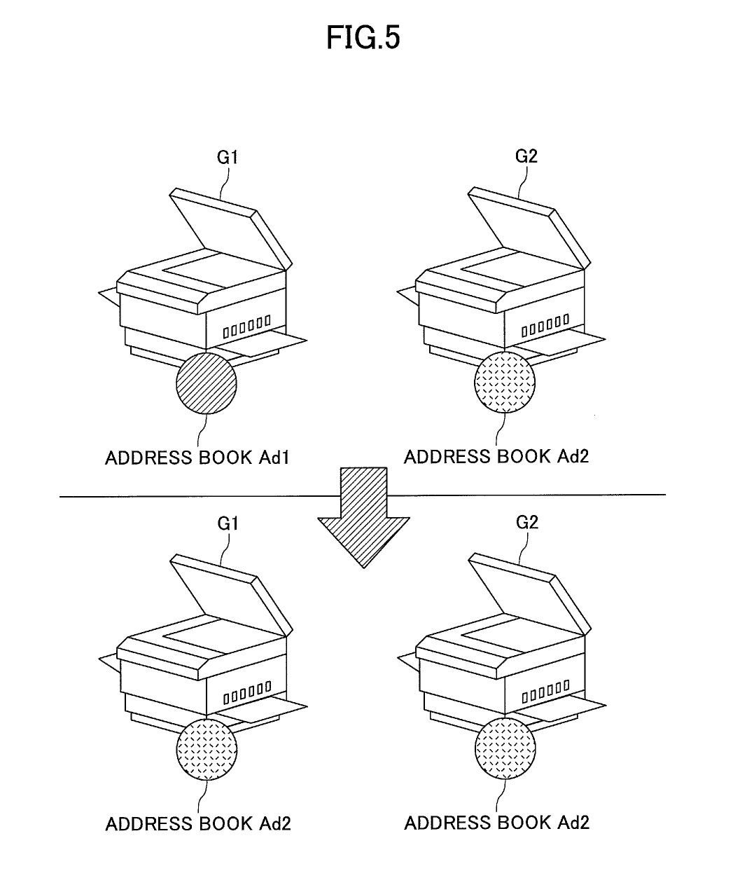

As illustrated as an example in the upper part of FIG. 5, when the image forming apparatus G1 has an address book Ad1, and the image forming apparatus G2 has an address book Ad2, one of the address book Ad1 and the address book Ad2 may be unified with the other one of the address book Ad1 and the address book Ad2 for improving the usability of the image forming apparatuses G1 and G2. In this case, for example, as illustrated in the lower part of FIG. 5, the address book Ad1 of the image forming apparatus G1 may be replaced with the address book Ad2 of the image forming apparatus G2.

In such a case, the user may, for example, attach a movable storage medium such as an SD card and a USB memory to a not-illustrated external I/F of the image forming apparatus G2 to copy the address book Ad2 stored in the NVRAM 14 of the image forming apparatus G2 to the attached movable recording medium. Subsequently, the user attaches the movable medium to an external I/F of the image forming apparatus G1 so as to allow the image forming apparatus G1 to read the address book Ad2 saved in the movable medium, and replace the existing address book Ad1 stored in the NVRAM 14 of the image forming apparatus G1 with the address book Ad2. Further, the user transmits the address book Ad2 of the NVRAM 14 of the image forming apparatus G2 to the image forming apparatus G1 via the network NW to replace the address book Ad1 stored in the NVRAM 14 of the image forming apparatus G1 with the address book Ad2.

That is, when the movable medium is attached to the external I/F, and an instruction to replace the current address book Ad1 of the NVRAM 14 with the address book Ad2 is transmitted by operations of the operations panel 22, the CPU 11 of the image forming apparatus G1 copies or moves the address book Ad2 stored in the movable medium into the NVRAM 14. When the CPU 11 copies or moves the address book Ad2 into the NVRAM 14, the CPU 11 deletes the existing address book Ad1 and replaces the address book Ad1 with the address book Ad2.

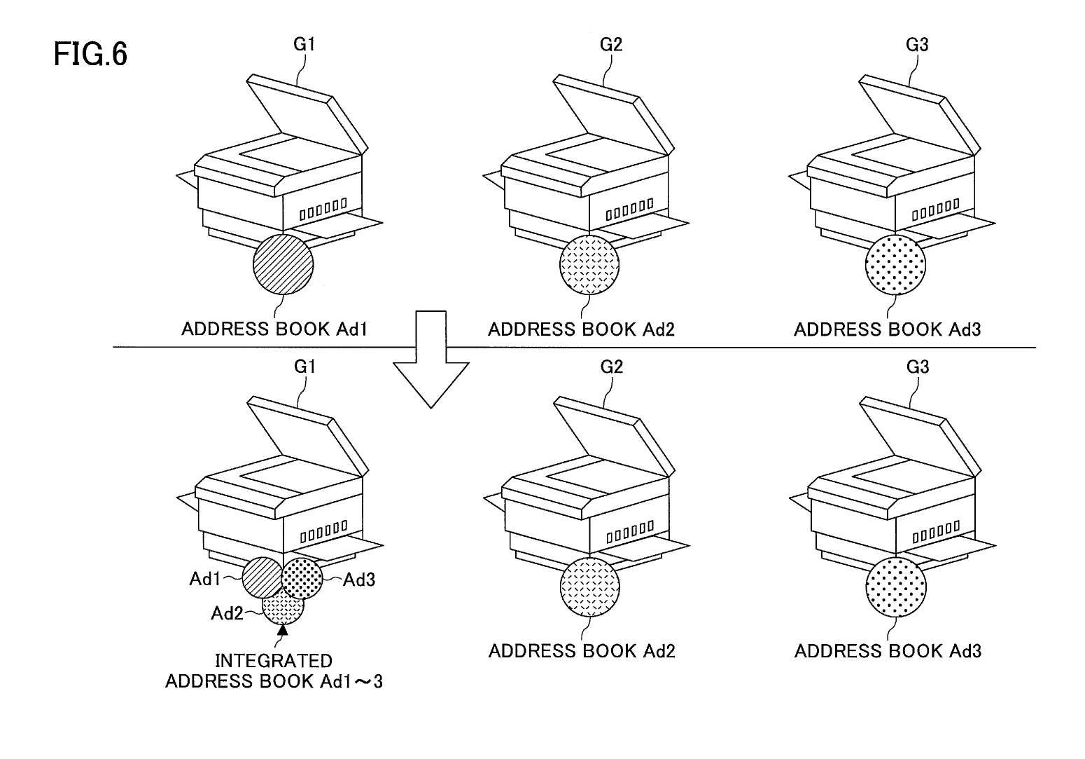

Further, as illustrated in an upper part of FIG. 6, when the image forming apparatus G1 has an address book Ad1, the image forming apparatus G2 has an address book Ad2, and the image forming apparatus G3 has an address book Ad3, the user may integrate the address books Ad1 to Ad3. For example, as illustrated in a lower part of FIG. 6, the address books Ad2 and Ad3 may be integrated with the address book Ad1 of the image forming apparatus G1.

In this case, the user copies the address book Ad2 of the image forming apparatus G2 and the address book Ad3 of the image forming apparatus G3 into the movable storage medium. The user then allows the image forming apparatus G1 to read the address books Ad2 and Ad3 saved in the movable storage medium to integrate the read address books Ad2 and Ad3 with the existing address book Ad1 in the NVRAM 14 of the image forming apparatus G1.

That is, the CPU 11 integrates the address books Ad2 and Ad3 with the address book Ad1 when the CPU 11 receives an instruction transmitted by the operations of the operations panel to integrate the address books Ad2 and Ad3 with the address book Ad1 of the NVRAM 14.

Subsequently, the CPU 11 verifies whether the address information items provided with the same address IDs differ from each other in an update process such as rewriting the address books Ad or integrating the address books Ad. When the address information items provided with the same address IDs differ from each other, the address ID of the different address information is changed such that the respective sets of the address information have different address IDs. Further, the CPU 11 verifies whether the same address information items are provided with the different address IDs. When the same address information items are provided with the different address IDs, an address book update process is performed to unify the same address information items having the different address IDs into one address information item with a desired one of the different IDs. Then the CPU 11 updates the address IDs and the address information, and then verifies whether there is any program information using the address ID before being updated in the program information book Pd. The CPU 11 performs a program information adjusting process such as changing the address ID of the program information before being updated into the address ID after being updated.

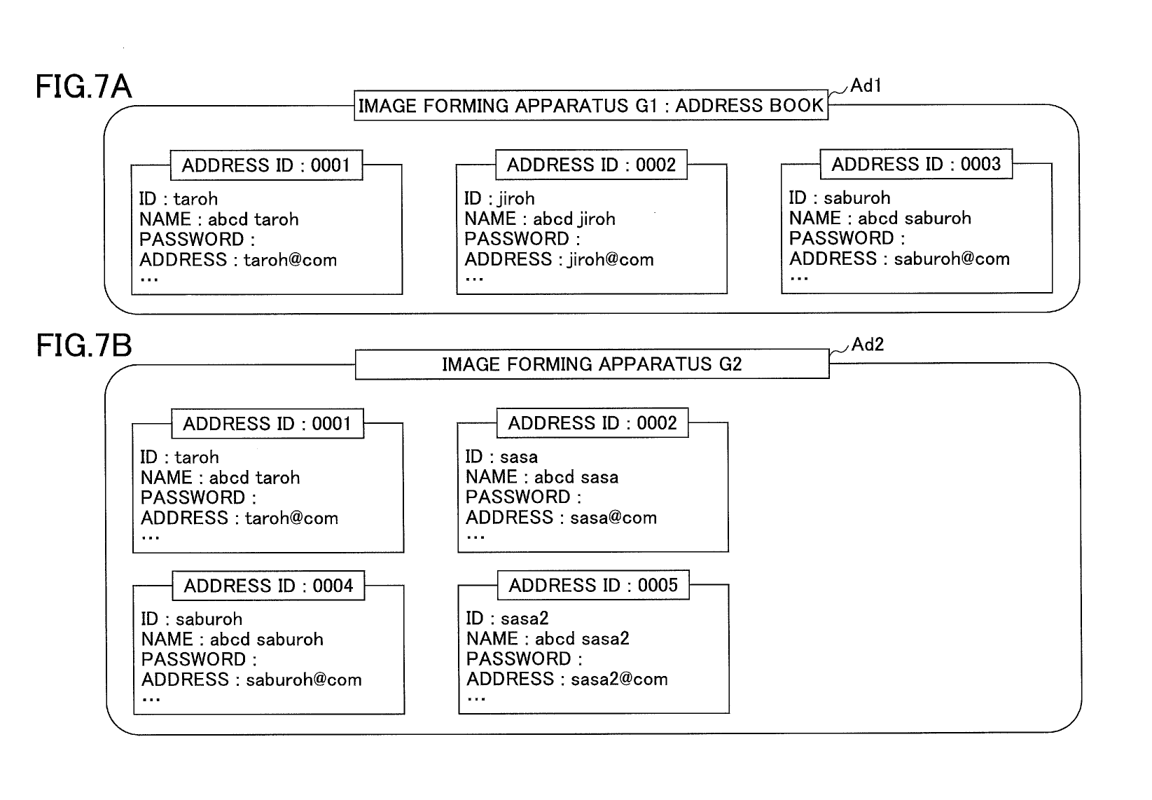

Specifically, as illustrated in FIGS. 7A and 7B, it is assumed that the image forming apparatus G1 currently includes the address book Ad1, and the image forming apparatus G2 currently includes the address book Ad2. Further, it is assumed that the address book Ad1 registers the address information having the address IDs “0001” to “0003”, and the address book Ad2 registers the address information having the address IDs “0001” to “0005” (see FIGS. 7A and 7B). Subsequently, the address books Ad1 and Ad2 are integrated; however, it is assumed in this example, that the address book Ad2 is integrated into the address book Ad1, for simplifying the illustration.

In the integration of the address books, the CPU 11 initially determines whether the address ID and the address information that are identical to those of the address book Ad1 are present in the address book Ad2.

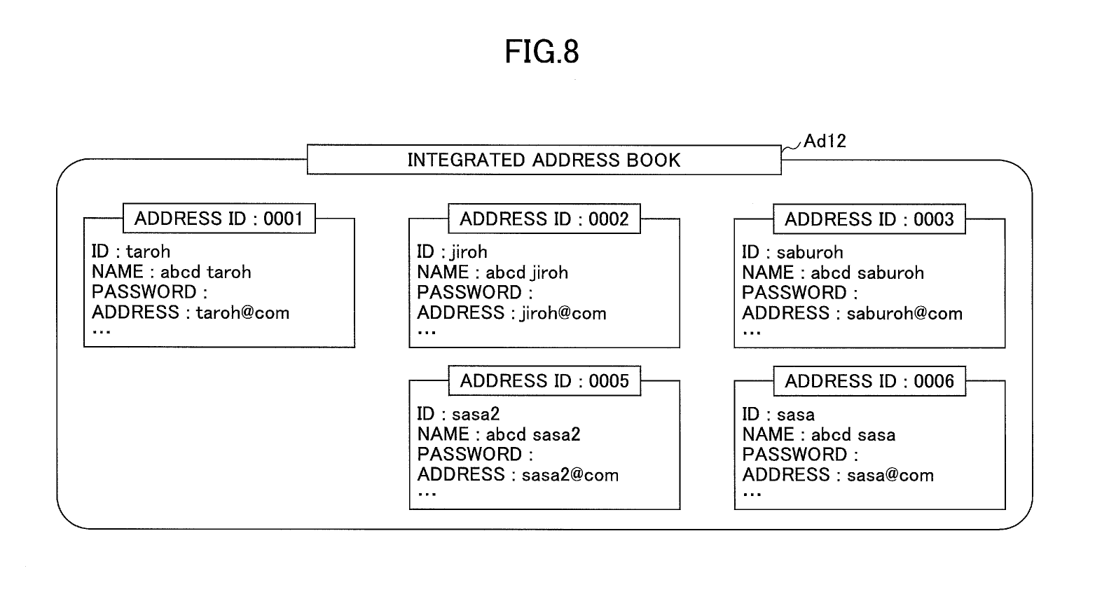

In the integration of the address books Ad, when the respective address books Ad1 and Ad2 have different address IDs with different address information items, as illustrated in FIGS. 7A and 7B, and FIG. 8, the respective address information items of the address IDs are retained as they are in the integrated address book Ad12.

As illustrated in FIGS. 7A and 7B, the address information having the same address ID as the address ID “0001” in the address book Ad1 is present in the address book Ad2, and the address information having the ID address “0001” in the address book Ad1 is the same as the address information having the ID address “0001” in the address book Ad2. In this case, as illustrated in FIG. 8, the address information having the address ID “0001” in the address book Ad1 is retained as it is in the integrated address book Ad12.

Further, as illustrated in FIGS. 7A and 7B, the address information having the address ID “0003” in the address book Ad1 is the same as the address information having the address ID “0004” in the address book Ad2 despite the fact that the address IDs are different from each other. Hence, in this case, as illustrated in FIG. 8, the address ID “003” and the corresponding address information of the integration source address book Ad1 may be retained in the integrated address book Ad12, and the address ID “004” and the corresponding address information in the address book Ad2 are deleted.

Further, as illustrated in FIGS. 7A and 7B, the address information having the same address ID (“0002”) as the address ID “0002” in the address book Ad1 is present in the address book Ad2, but the address information having the ID address “0002” in the address book Ad1 is different from the address information having the ID address “0002” in the address book Ad2. In this case, as illustrated in FIG. 8, the address information having the address ID “0002” in the address book Ad1 is provided with the address ID “0006”, and hence, the address information provided with the address ID “0006” is retained in the integrated address book Ad12.

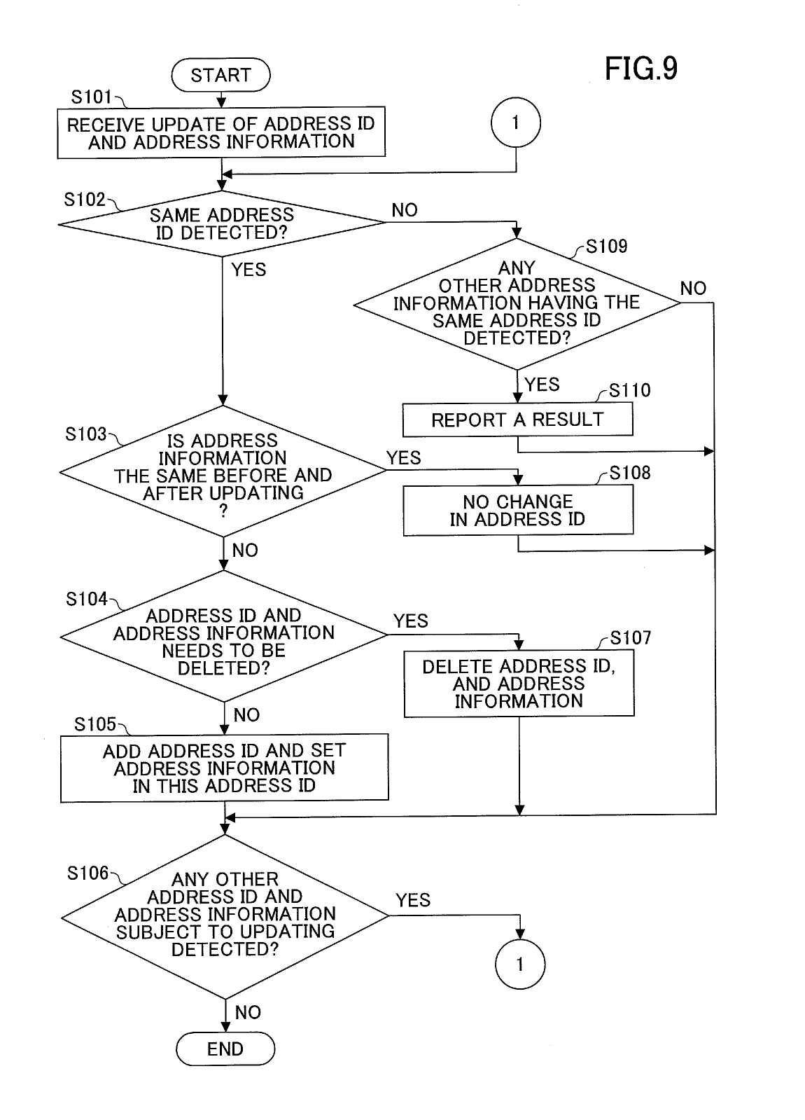

That is, the CPU 11 performs an update process as illustrated in FIG. 9. Initially, when the CPU 11 receives updates of the address ID and the address information (step S101), the CPU verifies whether the same address IDs are present (step S102).

In step S102, when the same address IDs are present (“YES” in step S102), the CPU 11 verifies whether the address information items having the same IDs before being updated are the same as those after being updated (step S103). That is, as indicated by the address IDs “0001”, and “0002” illustrated in FIGS. 7A and 7B, when the same address IDs are present in the image forming apparatus G1 and the image forming apparatus G2, the CPU 11 verifies whether the address information items having the same address IDs in the image forming apparatus G1 and the image forming apparatus G2 are identical.

In step S103, when the address information before being updated is not identical to the address information after being updated (“NO” in step S103), the CPU 11 verifies whether the update requested requires deletion of the address ID or the address information (step S104).

When the update requested does not require deletion of the address ID or the address information in step S104, the CPU 11 adds the address ID and sets the address information in the added address ID (step S105). That is, as indicated by the address ID “0002” illustrated in FIGS. 7A and 7B, when the same address IDs are present in the image forming apparatuses G1 and G2, but the address information corresponding to the same address IDs are different between the image forming apparatuses G1 and G2, the different address information items associated with the same address IDs are present unless the update requested requires “deletion”. Hence, as illustrated in FIG. 8, another address ID is added (the address ID “006” in FIG. 8), and one of the address information items having the same ID is set in the added address ID. In FIG. 8, the address information corresponding to the address ID “0002” in the image forming apparatus G2 is set as the address ID “0006”.

Thereafter, the CPU 11 verifies whether there are any other address IDs and address information items subject to being updated (step S106).

When there is another address ID or address information item subject to being updated in step S106, the CPU 11 returns to step S102 to proceed with the processes (steps S101 to S106) again, from the verification as to whether there is the same address ID with respect to the address ID subject to being updated.

In step S104, when the address ID or the address information is subject to being deleted (“YES” in step S104), the CPU 11 deletes the address ID or the address information subject to being deleted, and verifies whether there are other address ID or other address information subject to being updated (step S106).

In step S103, when the address information items corresponding to the same address IDs before being updated are identical to those address information items corresponding to the same address IDs after being updated (“YES” in step S103), the CPU 11 unifies these address IDs or the address information items into one address ID or one address information item without changing the address IDs (step S108). That is, in a case of the address ID “0001” in the image forming apparatus G1 and the address ID “0001” in the image forming apparatus G2 illustrated in FIGS. 7A and 7B, the address information items associated with the same address IDs “0001” in the image forming apparatus G1 and the image forming apparatus G2 are the same. Hence, the CPU 11 retains one of the same address information items associated with the address ID “0001” without changing the address ID and the address information, as illustrated in FIG. 8. When the CPU 11 unifies the same address IDs and the same address information into one address ID with one address information, the CPU 11 proceeds with the above-described processes (step S106, and steps S102 to S108) again, from the verification as to whether there are any other address IDs or address information subject to being updated.

In step S102, when the same address IDs are not present (“NO” in step S102), the CPU 11 verifies whether there are any other identical IDs having the same address information items (step S109).

When there are the same address information items having the different address IDs in step S109 (“YES” in step S109), the CPU 11 reports to a user such a result of the presence of the same address information items having the different address IDs by a method such as displaying the result on a display of the operations panel 22 (step S110). Upon the recognition of the report, the user operates the operations panel 22 to transmit an instruction such as unifying the address IDs into a selected one of the address IDs or retaining the different address IDSs as they are.

When the CPU 11 executes a process in accordance with the user's instruction to the above report, and proceeds with the above-described processes (step S106, and steps S102 to S108) again, from the verification as to whether there are any other address IDs or address information subject to being updated. For example, in FIGS. 7A and 7B, the address ID “0003” in the image forming apparatus G1 differs from the address ID “0004” in the image forming apparatus G2 but the address information associated with the address ID “0003” is identical to the address information associated with the address ID “0004”. Hence, the CPU 11 displays such a result on the display of the operations panel 22. When the user transmits an instruction to unify these different address IDs into one, the CPU 11 deletes one of the address IDs together with associated address information so as to retain the other address ID with associated address information as illustrated in FIG. 8. For example, the address ID “0004” and its associated address information are deleted and the address ID “0003” and its associated address information are retained.

Thereafter, the CPU 11 proceeds with step S106 to perform the processes (steps S106 to S110) again, from the verification as to whether there are any other address IDs or the address information subject to being updated, and when there is no other address ID or no other address information subject to being updated in step S106, the CPU 11 ends the address update process.

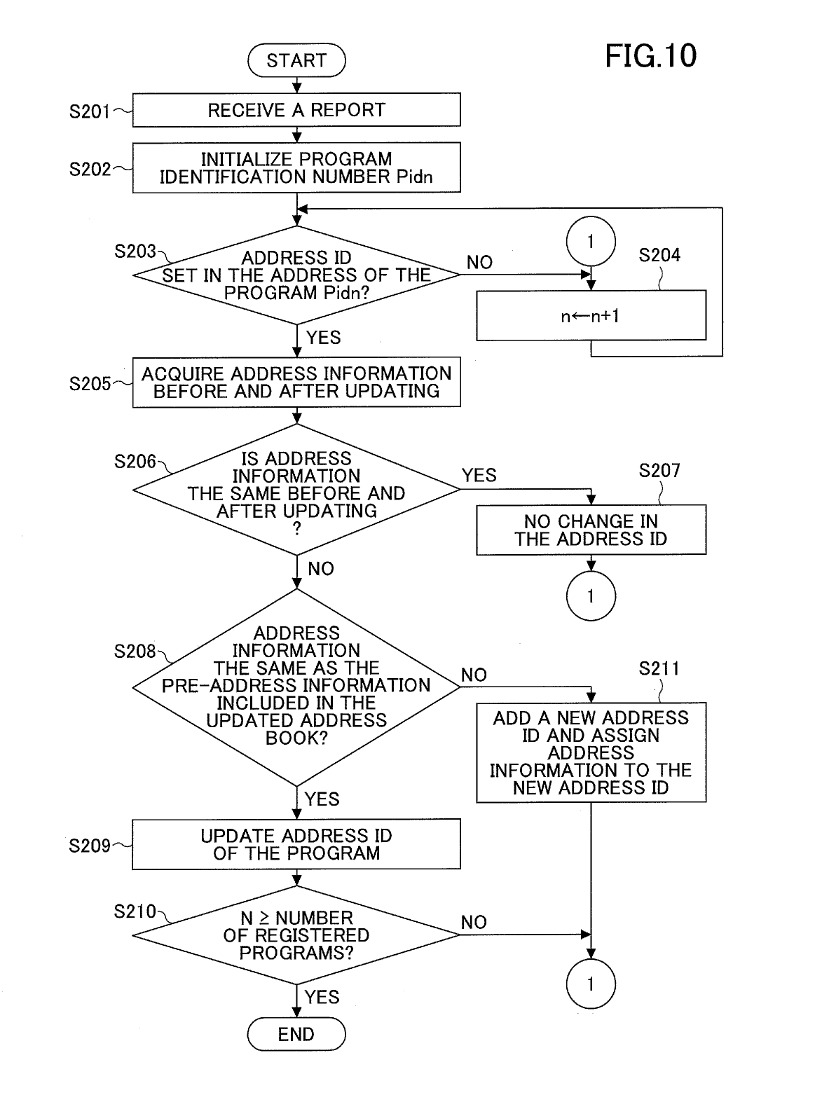

Then, when there occurs a change in the address ID or the address information before or after being updated as illustrated in the address book integration, the CPU 11 performs an adjusting process on the program information book Pd as illustrated in FIG. 10. Note that FIG. 10 illustrates a case of integrating the above-described address books Ad; however, the present invention is not limited to this example of integrating the address books Ad. For example, when the address ID or the address information is changed, the program information books Pd may be adjusted. The adjustment of the program information books Pd may be applied to all the image forming apparatuses G1 to Gn that use the address books Ad in which the address ID or the address information is changed.

In the adjusting process of the program information books Pd, that is, in a case of the address integration process illustrated, for example, from FIGS. 7A and 7B to FIG. 9, the CPU 11 stores the address books Ad1 and Ad2 before integration (before being changed) and an integrated address book Ad12 after being integrated (after the change) of the address books Ad1 and Ad2 in the RAM 13 or the like. The CPU 11 performs the adjusting process on the program information books Pd while referring to the address books Ad1, Ad2, and Ad12.

Initially, when the CPU 11 receives an integration report (step S201), the CPU initializes a program Pidn (n=1) for specifying the program information subject to being processed as illustrated in FIG. 10 (step S202).

The CPU 11 verifies whether an address ID is set in an address item of the program Pidn (step S203).

When the address ID is not set in the address item of the program Pidn (“NO” in step S203), the CPU 11 increments a variable n by “1” (step S204), and returns to step S203 to proceed with the above-described processes (steps S203 and S204) again.

When the address ID is set in the address item in step S203, the CPU 11 acquires the address information corresponding to the address ID from the address books Ad1, Ad2, and Ad12 before and after being integrated (before and after being updated).

The CPU 11 verifies whether the address information corresponding to the address ID before integration is identical to that after being integrated (step S206).

When the address information corresponding to the address ID before integration is identical to that after being integrated (the address information before and after being updated) (“YES” in step S206), the CPU 11 returns to step S204 without changing the address ID of the address item in the program information books Pd. That is, in this case, when the address information before integration is the same as the address information after being integrated, there is no change in the address information specified by the set address ID set in the program information of the program Pidn, and hence, the CPU 11 does not change the address ID of the program information.

The CPU 11 proceeds with the above-described processes (steps S204 to S207) again after returning to step S204.

When the address information before integration differs from the address information after being integrated (the address information before and after being updated) (“NO” in step S206), the CPU 11 verifies whether the address information identical to the address information items of the address IDs in the address books Ad1 and Ad2 before being updated is present in the address book Ad12 after being integrated (step S208).

When the address information identical to the address information items of the address IDs in the address books Ad1 and Ad2 before being updated is present in the address book Ad12 after being integrated (“YES” in step S208), the CPU 11 updates the address ID of the program information in the program Pidn with the address ID corresponding to the address information in the address book Ad12 that is the same after being integrated (step S209).

When the CPU 11 updates the address ID, the CPU 11 verifies whether the variable n is greater than a registered number of programs in the program information book Pd, that is, the CPU 11 verifies whether all the programs have been updated (step S210).

When the variable n is less than the registered number of programs (“NO” in step S210), the CPU 11 returns to step S204, and increments the variable n by “1” (step S204). When the CPU 11 increments the variable n, the CPU 11 returns to step S203 to proceed with above-described processes (steps S203 to S210) again.

When the address information identical to the address information before being updated is not present in the address book Ad12 after being updated in step S208 (“NO” in step S208), the CPU 11 adds a new address ID to the address book Ad, and sets the address information before being updated in the new address ID. When the CPU 11 updates the address book Ad, the CPU 11 updates the new address ID by setting the new address ID in the address of the program information in the program Pidn (step S211).

When the CPU 11 updates the address ID and the setting of the program information, the CPU increments the variable n by “1” (step S204). When the CPU 11 increments the variable n, the CPU 11 returns to step S203 to proceed with above-described processes (steps S203 to S211) again.

When the variable n is greater than the registered number of programs (“YES” in step S210), the CPU 11 ends the program information book updating process.

Note that in the above description, the image forming apparatuses G1 to Gn are given as examples of the embodiments; however, the embodiments of the present invention are not limited to these examples. The embodiments may be applied, in general, to any image processing apparatuses configured to perform operational processes by utilizing the address books Ad and the program information books Ps.

As described above, each of the image forming apparatuses G1 to Gn of the embodiments may include an NVRAM (an address information storage) 14 configured to store recipient information relating to a recipient and an address of the recipient as address information in association with an address ID (an address identifier); an NVRAM (a program storage) 14 configured to store setting information as program information in association with a program Pid (a program identifier), the setting information including program identification information for specifying a program and the address ID (the address identifier) for specifying the address for use in execution of the program; a CPU (a program execution unit) 11 configured to execute the program associated with the program Pid based on the setting information; a CPU (an address information change unit) 11 configured to change the address information stored in the NVRAM 14 serving as the address information storage, and change the address ID (the address identifier) necessary for the change in the address information; and a CPU (an information change adjusting unit) 11 configured to adjust, upon a change in at least one of the address ID (the address identifier) and the address information, the address ID (the address identifier) of the program information including the address ID (the address identifier) stored in the NVRAM 14 serving as the program storage based on the address ID (the address identifier) and the address information before being changed and the address ID (the address identifier) and the address information after being changed, in response to the change in a corresponding one of the address ID (the address identifier) and the address information.

Accordingly, when there occurs a change in the address ID or the address information associated with the address ID at the time of executing the program based on the program information specifying the address by the address ID (the address identifier), the address ID in the program information may be adjusted based on the change in the address ID or the address information. As a result, even when there occurs a change in the address information managed by the address ID, operations utilizing the address ID may be adjusted by adjusting management of the address IDs and the address information.

Further, the information processing system 1 of the embodiments includes a plurality of image forming apparatuses (information processing apparatuses) G1 to Gn connected via a network NW. Each of the image forming apparatuses G1 to Gn serving as the information processing apparatuses may include an NVRAM (an address information storage) 14 configured to store recipient information relating to a recipient and an address of the recipient as address information in association with an address ID (an address identifier); an NVRAM (a program storage) 14 configured to store setting information as program information in association with a program Pid (a program identifier), the setting information including program identification information for specifying a program and the address ID (the address identifier) for specifying the address for use in execution of the program; a CPU (a program execution unit) 11 configured to execute the program associated with the program Pid based on the setting information; a CPU (an address information change unit) 11 configured to change the address information stored in the NVRAM 14 serving as the address information storage, and change the address ID (the address identifier) necessary for the change in the address information; and a CPU (an information change adjusting unit) 11 configured to adjust, upon a change in at least one of the address ID (the address identifier) and the address information, the address ID (the address identifier) of the program information including the address ID (the address identifier) stored in the NVRAM 14 serving as the program storage based on the address ID (the address identifier) and the address information before being changed and the address ID (the address identifier) and the address information after being changed, in response to the change in a corresponding one of the address ID (the address identifier) and the address information.

Accordingly, in the information processing system 1, when there occurs a change in the address ID (the address identifier) or the address information associated with the address ID at the time of executing the program based on the program information specifying the address by the address ID (the address identifier), the address ID in the program information may be adjusted based on the change in the address ID or the address information. As a result, even when there occurs a change in the address information managed by the address ID, appropriate operations utilizing the address ID may be implemented by adjusting management of the address IDs and the address information items.

In addition, the image forming apparatuses G1 to Gn of the embodiments may be configured to execute an information processing method. The method includes causing a control processor such as a CPU 11 to store in an NVRAM (an address information storage) 14 recipient information relating to a recipient and an address of the recipient as address information in association with an address ID (an address identifier); causing a control processor such as a CPU 11 to store in an NVRAM (a program storage) 14 setting information as program information in association with a program Pid (a program identifier), the setting information including program identification information for specifying a program and the address ID (the address identifier) for specifying the address for use in execution of the program; causing a CPU (a program execution unit) 11 to execute the program associated with the program Pid based on the setting information; causing a CPU (an address information change unit) 11 to change the address information stored in the NVRAM 14 serving as the address information storage, and change the address ID (the address identifier) necessary for the change in the address information; and causing a CPU (an information change adjusting unit) 11 to adjust, upon a change in at least one of the address ID (the address identifier) and the address information, the address ID (the address identifier) of the program information including the address ID (the address identifier) stored in the NVRAM 14 serving as the program storage based on the address ID (the address identifier) and the address information before being changed and the address ID (the address identifier) and the address information after being changed, in response to the change in a corresponding one of the address ID (the address identifier) and the address information.

Accordingly, when there occurs a change in the address ID or the address information associated with the address ID at the time of executing the program based on the program information specifying the address by the address ID (the address identifier), the address ID in the program information may be adjusted based on the change in the address ID or the address information. As a result, even when there occurs a change in the address information managed by the address ID, appropriate operations utilizing the address ID may be implemented by adjusting management of the address IDs and the address information.

Moreover, the image forming apparatuses G1 to Gn of the embodiments may be configured to execute an information processing program when a non-transitory computer-readable recording medium storing the information processing program is placed in the image forming apparatuses G1 to Gn and the information processing program is loaded. The information processing program includes causing a control processor such as a CPU 11 to store in an NVRAM (an address information storage) 14 recipient information relating to a recipient and an address of the recipient as address information in association with an address ID (an address identifier); causing a control processor such as a CPU 11 to store in an NVRAM (a program storage) 14 setting information as program information in association with a program Pid (a program identifier), the setting information including program identification information for specifying a program and the address ID (the address identifier) for specifying the address for use in execution of the program; causing a CPU (a program execution unit) 11 to execute the program associated with the program Pid based on the setting information; causing a CPU (an address information change unit) 11 to change the address information stored in the NVRAM 14 serving as the address information storage, and change the address ID (the address identifier) necessary for the change in the address information; and causing a CPU (an information change adjusting unit) 11 to adjust, upon a change in at least one of the address ID (the address identifier) and the address information, the address ID (the address identifier) of the program information including the address ID (the address identifier) stored in the NVRAM 14 serving as the program storage based on the address ID (the address identifier) and the address information before being changed and the address ID (the address identifier) and the address information after being changed, in response to the change in a corresponding one of the address ID (the address identifier) and the address information.

Accordingly, when there occurs a change in the address ID or the address information associated with the address ID at the time of executing the program based on the program information specifying the address by the address ID (the address identifier), the address ID in the program information may be adjusted based on the change in the address ID or the address information. As a result, even when there occurs a change in the address information managed by the address ID, appropriate operations utilizing the address ID may be implemented by adjusting management of the address IDs and the address information.

In addition, each of the image forming apparatuses G1 to Gn of the embodiments may further include a changed address information receiver such as the operations panel 22 and the network I/F 15 configured to receive predetermined numbers of the address IDs and the address information items associated with the address IDs after being changed. In the image forming apparatuses G1 to Gn, the CPU 11 serving as the address information change unit replaces an address ID and address information stored in the NVRAM 14 serving as the address information storage with the address ID and the address information received by the address information change unit.

Accordingly, even when the address ID and the address information in the NVRAM 14 of one of the image forming apparatuses G1 to Gn is replaced with the address ID and the address information stored in the NVRAM 14 in the other one of the image forming apparatuses G1 to Gn, appropriate process operations utilizing the address ID may be implemented by appropriately adjusting management of the address IDs and the address information.

Moreover, in the image forming apparatuses G1 to Gn of the embodiments, the CPU 11 serving as the address information change unit integrates the address ID and the address information received by the changed address information receiver and an address ID and address information stored in the NVRAM 14 serving as the address information storage to generate an integrated address information.

Accordingly, even when the address ID and the address information in the NVRAM 14 of one of the image forming apparatuses G1 to Gn is integrated with the address ID and the address information stored in the NVRAM 14 in the other one of the image forming apparatuses G1 to Gn, appropriate process operations utilizing the address ID may be implemented by appropriately adjusting management of the address IDs and the address information.

In addition, in the image forming apparatuses G1 to Gn of the embodiments, when two or more address IDs each associated with identical address information are generated along with a change in at least one of the address ID and the address information, the CPU 11 serving as the address information change unit unifies the address IDs associated with the identical address information into one address ID with the identical address information.

Accordingly, the address information may be appropriately managed based on the address ID associated with the address information, appropriate process operations using the address ID may be implemented.

Moreover, in the image forming apparatuses G1 to Gn of the embodiments, when two or more different address information items are generated in association with the same address ID along with a change in at least one of the address ID and the address information, the CPU 11 serving as the address information change unit sets a different ID for each of the different address information items.

Accordingly, the address information may be appropriately managed based on the address ID associated with the address information, appropriate process operations using the address ID may be implemented.

Moreover, each of the image forming apparatuses G1 to Gn of the embodiments further includes an information processing part configured to manage program information and address information, in the image forming apparatuses G1 to Gn, image processing is performed by executing a program based on the program information under the management of the information processing part. Each of the image forming apparatuses G1 to Gn of the embodiments includes a controller 10 as the information processing part.

Accordingly, when there occurs a change in the address ID or the address information associated with the address ID in the image forming apparatuses G1 to Gn configured to execute the program based on the program information specifying the address by the address ID (the address identifier), the address ID in the program information may be adjusted based on the change in the address ID or the address information. As a result, even when there occurs a change in the address information managed by the address ID, appropriate operations utilizing the address ID may be implemented by adjusting management of the address IDs and the address information.

The embodiments of the invention may provide a technology capable of appropriate process operations utilizing the address identifiers and the address identification information items may be implemented even when there occurs a change in the address information items managed by the address identifiers.

The preferred embodiments are described above by giving specific examples; however, the present invention is not limited to the specifically disclosed embodiments and examples. Various alterations and modifications may be made without departing from the gist of the invention as claimed within the scope of the present invention.

The present application is based on and claims the benefit of priority of Japanese Priority Application No. 2014-179792 filed on Sep. 4, 2014, the entire contents of which are hereby incorporated herein by reference.

What is claimed is:

1. An information processing apparatus comprising:
an address information storage configured to store recipient information relating to a recipient and an address of the recipient in association with an address identifier as address information;
a program storage configured to store setting information in association with a program identifier as program information, the setting information including program identification information for specifying a program and the address identifier for specifying the address for use in execution of the program;
a program execution unit configured to execute the program associated with the program identifier based on the setting information;
an address information change unit configured to change the address information stored in the address information storage, and change the address identifier along with the change in the address information; and
an information change adjusting unit configured to adjust, upon detecting a change in at least one of the address identifier and the address information, the address identifier of the program information including the address identifier stored in the program storage based on the address identifier and the address information before being changed and the address identifier and the address information after being changed, in response to the change in a corresponding one of the address identifier and the address information.

2. The information processing apparatus as claimed in claim 1, further comprising:
a changed address information receiver configured to receive predetermined numbers of the address identifiers and address information items after being changed, wherein
the address information change unit replaces the address identifier and the address information stored in the address information storage with the address identifier and the address information received by the changed address information receiver.

3. The information processing apparatus as claimed in claim 2, wherein
the address information change unit integrates the address identifier and the address information received by the changed address information receiver with the address identifier and the address information stored in the address information storage to generate integrated address information.

4. The information processing apparatus as claimed in claim 1, wherein
when two or more address identifiers associated with identical address information are generated along with a change in at least one of the address identifier and the address information, the address information change unit unifies the generated address identifiers associated with the identical address information into one address identifier with the identical address information.

5. The information processing apparatus as claimed in claim 1, wherein
when two or more different address information items are generated in association with a same address identifier along with a change in at least one of the address ID and the address information, the address information change unit sets a different identifier for each of the different address information items.

6. An image forming apparatus comprising:
the information processing apparatus as claimed in claim 1 serving as an information processing part configured to manage program information and address information, wherein a program is executed based on the program information under the management of the information processing part.

7. An information processing system comprising:
a plurality of information processing apparatuses connected via a network, wherein
each of the information processing apparatuses includes
an address information storage configured to store recipient information relating to a recipient and an address of the recipient in association with an address identifier as address information;
a program storage configured to store setting information in association with a program identifier as program information, the setting information including program identification information for specifying a program and the address identifier for specifying the address for use in execution of the program;
a program execution unit configured to execute the program associated with the program identifier based on the setting information;
an address information change unit configured to change the address information stored in the address information storage, and change the address identifier along with the change in the address information; and
an information change adjusting unit configured to adjust, upon detecting a change in at least one of the address identifier and the address information, the address identifier of the program information including the address identifier stored in the program storage based on the address identifier and the address information before being changed and the address identifier and the address information after being changed, in response to the change in a corresponding one of the address identifier and the address information.

8. An information processing method comprising:
storing, in an address information storage, recipient information relating to a recipient and an address of the recipient as address information in association with an address identifier;
storing, in a program storage, setting information in association with a program identifier as program information, the setting information including program identification information for specifying a program and the address identifier for specifying the address for use in execution of the program;
executing the program associated with the program identifier based on the setting information;
changing the address information stored in the address information storage, and changing the address identifier along with the change in the address information; and
adjusting, upon detecting a change in at least one of the address identifier and the address information, the address identifier of the program information including the address identifier stored in the program storage based on the address identifier and the address information before being changed and the address identifier and the address information after being changed, in response to the change in a corresponding one of the address identifier and the address information.
